(19) United States
(12) Patent Application Publication
(10) Pub. No.: US 2013/0006650 A1
(43) Pub. Date: Jan. 3, 2013

(54) METHOD AND APPARATUS FOR MIGRATING BETWEEN DEVICES WHILE INTERACTING WITH A HEALTHCARE APPLICATION

(75) Inventors: Radu Catalin Bocirnea, New Westminster (CA); Cliff Edwards, Delta (CA); George Kovacs, Vancouver (CA)

(73) Assignee: McKesson Financial Holdings

(21) Appl. No.: 13/172,262

(22) Filed: Jun. 29, 2011

(51) Int. Cl. G06Q 50/00

(52) U.S. Cl. 705/2

(57) ABSTRACT

Methods and apparatuses are provided for facilitating migration from a first device to a second device while interacting with a healthcare application. In this regard, a method may cooperate with the first device to establish a connection therewith based upon a proximity-based identification technique. Such cooperation may occur while the user is interacting with the healthcare application on the first device. The method may also authenticate the user of the first device based upon information, such as authentication credentials, provided by the first device regarding prior synchronization of the user by the first device. The method may also environmentally synchronize with the first device. In this regard, the method may environmentally synchronize with the first device by providing for interaction with the healthcare application via a processor and by providing a common context with that of the first device including display of a common image.

### TECHNOLOGICAL FIELD

Embodiments of the present invention relate generally to computer technology and, more particularly, to methods and apparatuses for migrating between devices while interacting with a healthcare application.

### BACKGROUND

Medical imaging often includes images of regions of the human body for clinical purposes, such as examination, diagnosis and/or treatment. These images may be acquired by a number of different imaging modalities including for example, ultrasound (US), magnetic resonance (MR), positron emission tomography (PET), computed tomography (CT), mammography (MG), digital radiography (DR), computed radiography (CR) or the like. In a number of example medical imaging workflows, such as in the case of a Picture Archiving and Communication System (PACS), an image study for a patient may include one or more acquired images of the patient along with information that may reside with or otherwise accompany the images. The information may include, for example, a study identifier as well as patient information such as a patient's name, demographic information, medical record number or the like. The information may also include, for example, an indication of the modality that acquired the images of the study, the body region depicted in the images, and/or the medical facility with the modality that acquired the images. Once a patient study has been created, the study may be stored in the database of a central storage device. The images of the patient study may then be accessed and viewed via a dedicated viewer, such as a PACS workstation.

PACS workstations are generally fixed terminals that are visited by a healthcare provider in order to log into PACS so as to access a patient study. Over the past few years, however, mobile devices, such as mobile telephones, personal digital assistants (PDAs), tablet computers or the like, have become ubiquitous and as the computing power of such mobile devices has increased, users of the mobile devices have utilized the mobile devices to perform a wide variety of functions conventionally performed by fixed workstations, personal computers or the like. For example, mobile devices have been utilized to access PACS images and related patient studies. By utilizing their mobile devices, users may review the images at locations remote from the PACS workstations.

However, the size and resolution of a display of a mobile device is less than that of a PACS workstation. Thus, users may sometimes desire to transition from accessing PACS images and related patient studies via a mobile device to accessing the PACS via a PACS workstation, such as to view images at greater resolution and an increased size. Conversely, the user of a PACS workstation may sometimes desire to transition to a mobile device in order to continue to access the PACS images and related patient studies at a location remote from the PACS workstation. In such instances, however, the user must separately log into and access the PACS from each device, that is, from the PACS workstation and separately from the mobile device. As the log in process may require the entry of authentication credentials and other log in information by the user, the user may be inconvenienced and delayed in the process of transitioning from one device to another. Additionally, a user may be in the process of reviewing a particular PACS patient study when the user decides to transition to another device. In order to continue the review of the patient study upon the other device, the user must generally repeat the navigational sequence in order to identify the patient and, in turn, the particular aspect of the patient study that is of interest. Such navigational sequences may sometimes be lengthy and convoluted and, as such, a user must frequently repeat a number of selections upon transitioning to another device in order to simply return to the same patient study that was under review at the time of the transition. As such, it would be desirable to provide an improved technique for transitioning from a first device to a second device while continuing to interact with PACS or another healthcare application.

### BRIEF SUMMARY

Methods and apparatuses are provided according to an embodiment of the present invention for facilitating migration from a first device to a second device while interacting with a healthcare application, such as PACS or a radiology information system (RIS). For example, a method and apparatus of one embodiment facilitates migration from a PACS workstation to a mobile device while continuing to permit the user to interact with a healthcare application, while the method and apparatus of another embodiment facilitates migration from a mobile device to a PACS workstation while similarly continuing to permit the user to interact with a healthcare application. Among other features, the method and apparatus of one embodiment may provide for environmental synchronization of the devices such that the context of the device to which the user transitions is automatically synchronized with that of the device from which the user is transitioning, thereby providing for a relatively efficient and seamless transition.

In one embodiment, a method of migrating from a first device to a second device while interacting with a healthcare application is provided. The method of this embodiment includes cooperating with the first device to establish a connection therewith based upon a proximity-based identification technique. Such cooperation may occur while the user is interacting with the healthcare application on the first device. The method of this embodiment also authenticates the user of the first device based upon information, such as authentication credentials, provided by the first device regarding prior synchronization of the user by the first device. The method of this embodiment also environmentally synchronizes with the first device. In this regard, the method may environmentally synchronize with the first device by providing for interaction with the healthcare application via a processor and by providing a common context with that of the first device including display of a common image. For example, the method may provide data regarding a patient or a study that was presented by the first device upon migration therefrom.

In another embodiment, an apparatus for migrating from a first device to a second device while interacting with a healthcare application is provided. The apparatus of this embodiment includes a processor configured to cause the apparatus to cooperate with the first device to establish a connection therewith based upon a proximity-based identification technique. Such cooperation may occur while the user is interacting with the healthcare application on the first device. The processor of this embodiment is also configured to cause the apparatus to authenticate the user of the first device based upon information, such as authentication credentials, provided by the first device regarding prior synchronization of the user by the first device. The processor of this embodiment is also configured to cause the apparatus to environmentally synchronize with the first device. In this regard, the processor may be configured to cause the apparatus to environmentally synchronize with the first device by providing for interaction with the healthcare application and by providing a common context with that of the first device including display of a common image. For example, the processor may be configured to cause the apparatus to provide data regarding a patient or a study that was presented by the first device upon migration therefrom.

In a further embodiment, a method of migrating from a first device to a second device while interacting with a healthcare application is provided that includes interacting with the healthcare application, via a processor, including display of an image. The method of this embodiment also establishes a connection with the second device based upon a proximity-based identification technique. The method of this embodiment provides information, such as authentication credentials, to the second device regarding prior authentication of the user by the first device. As a result of the authentication of the user by the second device, the second device is permitted to be environmentally synchronized with the first device. In this regard, the environmental synchronization may include interaction with the healthcare application and provision of a common context with that of the first device including display of the image.

In yet another embodiment, an apparatus for migrating from a first device to a second device while interacting with a healthcare application is provided that includes a processor configured to cause the apparatus to interact with the healthcare application including display of an image. The processor of this embodiment is also configured to cause the apparatus to establish a connection with the second device based upon a proximity-based identification technique. The processor of this embodiment is also configured to cause the apparatus to provide information, such as authentication credentials, to the second device regarding prior authentication of the user by the first device. As a result of the authentication of the user by the second device, the second device is permitted to be environmentally synchronized with the first device. In this regard, the environmental synchronization may include interaction with the healthcare application and provision of a common context with that of the first device including display of the image.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system in which first and second devices may interact with a healthcare application in accordance with an example embodiment;

FIG. 2 is a block diagram of an apparatus that may be embodied by the first device or the second device in accordance with an example embodiment; and

FIG. 3 is a flowchart illustrating operations performed in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Further, the apparatus and method of example embodiments of the present invention will be primarily described in conjunction with medical-imaging applications. It should be understood, however, that the apparatus and method may be utilized in conjunction with a variety of other applications, both in the medical industry and outside the medical industry. Like numbers refer to like elements throughout.

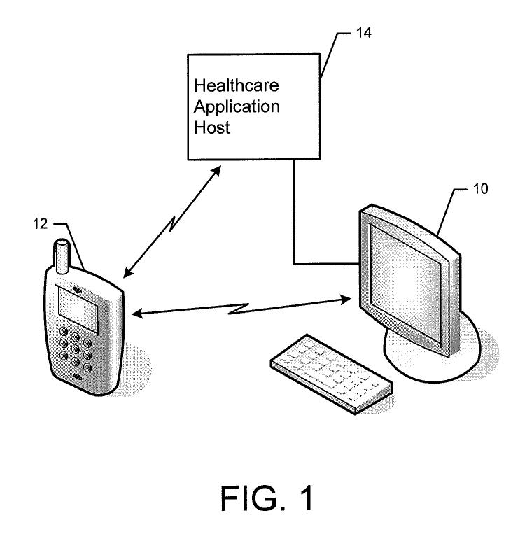

FIG. 1 illustrates a system that may benefit from an example embodiment of the present invention. As shown, the system includes one or more workstations 10, such as computer terminals or other fixed computing devices, as well as one or more mobile terminals 12, such as cellular telephones, PDAs, tablet computers or the like. Although FIG. 1 shows only a single workstation and a single mobile terminal, the system can include any number of workstations and any number of mobile terminals. The system also includes a healthcare application host 14 that is configured to communicate with the workstations and the mobile terminals. In one embodiment, the healthcare application host is embodied by a server that is remote from the workstations and mobile terminals and may be accessed via network, as described below. Alternatively, the healthcare application host may be co-located with one of the workstations or the mobile terminals.

Regardless of the architecture, the workstations 10 and/or the mobile terminals 12 may communicate with the healthcare application host 14 via a wired network, such as a local area network (LAN), an intranet, the internet or the like, as shown, for example, by the interconnection between the healthcare application host and the workstation of FIG. 1. Alternatively, or additionally, the healthcare application host and the workstations and/or the mobile terminals may communicate via a wireless network, such as a cellular network, a wireless local area network (WLAN) using Wi-Fi or the like, as shown, for example, by the wireless connection illustrated between the healthcare application host and the mobile terminal of FIG. 1.

The healthcare application host 14 may provide access to a wide variety of healthcare applications to the workstations 10 and mobile terminals 12. In one embodiment, the healthcare application host supports a PACS or a RIS (hereinafter generically referenced as a PACS) such that the workstations and the mobile terminals may access the PACS via communication with the healthcare application host. As such, the method and apparatus of one example embodiment will be described below in conjunction with a healthcare application host that provides access to a PACS, although it should be recognized that the healthcare application host may provide access to a number of different healthcare applications in other embodiments.

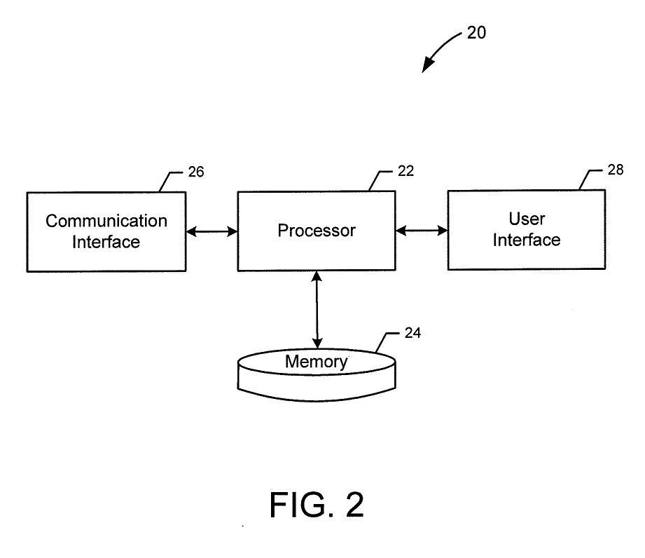

FIG. 2 illustrates a block diagram of an apparatus 20 according to some example embodiments that may be embodied by the workstation 10 or by the mobile terminal 12. In some example embodiments, the apparatus includes various means for performing the various functions described herein. These means may include, for example, one or more of a processor 22, memory 24, communication interface 26 and/or user interface 28 for performing the various functions herein described. The means of the apparatus as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 24) that is executable by a suitably configured processing device (e.g., the processor 22), or some combination thereof.

The processor 22 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor may comprise a plurality of processors. The plurality of processors may be embodied on a single computing device or may be distributed across a plurality of computing devices collectively configured to function as the apparatus. The plurality of processors may be in operative communication with each other and may be collectively configured to perform one or more functionalities of the apparatus as described herein. In some example embodiments, the processor is configured to execute instructions stored in the memory 24 or otherwise accessible to the processor. These instructions, when executed by the processor, may cause the apparatus 20 to perform one or more of the functionalities of the apparatus as described herein. As such, whether configured by hardware or software methods, or by a combination thereof, the processor may comprise an entity capable of performing operations according to embodiments of the present invention while configured accordingly. Thus, for example, when the processor is embodied as an ASIC, FPGA or the like, the processor may comprise specifically configured hardware for conducting one or more operations described herein. Alternatively, as another example, when the processor is embodied as an executor of instructions, such as may be stored in the memory, the instructions may specifically configure the processor to perform one or more algorithms and operations described herein.

The memory 24 may include, for example, volatile and/or non-volatile memory. Although illustrated in FIG. 2 as a single memory, the memory may comprise a plurality of memories. The plurality of memories may be embodied on a single computing device or distributed across a plurality of computing devices. The memory may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory may comprise any non-transitory computer readable storage medium. The memory may be configured to store information, data, applications, instructions, or the like for enabling the apparatus 20 to carry out various functions in accordance with example embodiments of the present invention. For example, in some example embodiments, the memory is configured to buffer input data for processing by the processor 22. Additionally or alternatively, in some example embodiments, the memory is configured to store program instructions for execution by the processor. The memory may store information in the form of static and/or dynamic information.

The communication interface 26 may be embodied as any device or means embodied in circuitry, hardware, a computer program product comprising computer readable program instructions stored on a computer readable medium (e.g., the memory 24) and executed by a processing device (e.g., the processor 22), or a combination thereof that is configured to receive and/or transmit data from/to another device, such as, for example, the healthcare application host 14 as well as the other of the mobile terminal 12 or the workstation 10. In some example embodiments, the communication interface is at least partially embodied as or otherwise controlled by the processor. In this regard, the communication interface may be in communication with the processor, such as via a bus. The communication interface may include, for example, an antenna, a transmitter, a receiver, a transceiver and/or supporting hardware or software for enabling communications with another computing device. The communication interface may be configured to receive and/or transmit data using any protocol that may be used for communications between computing devices. As an example, the communication interface may be configured to receive and/or transmit data using any protocol and/or communications technology that may be used for communicating with the other devices. The communication interface may additionally be in communication with the memory and/or user interface 28, such as via a bus.

The user interface 28 may be in communication with the processor 22 to receive an indication of a user input and/or to provide an audible, visual, mechanical, or other output to a user. As such, the user interface 28 may include, for example, a keyboard, a mouse, a joystick, a display, a touch screen display, a microphone, a speaker, and/or other input/output mechanisms. The user interface may be in communication with the memory 24 and/or communication interface 26, such as via a bus.

In accordance with an example embodiment of the present invention, a method and apparatus 20 are provided for facilitating migration from a first device to a second device while interacting with a healthcare application. This migration may proceed in either direction, that is, from the workstation 10 to the mobile terminal 12, such as in an instance in which a user wishes to continue to access the healthcare application while the user moves away from the fixed workstation, or from the mobile terminal to the workstation, such as in an instance in which a user wishes to continue to interact with the healthcare application, albeit in potentially greater resolution and in a greater size upon the workstation. As described below, this migration may be facilitated by the method and apparatus of embodiments of the present invention so as to be accomplished in an efficient manner with little interaction from the user and with the user having access to the same context, such as the same images, from the same patient or study following the migration.

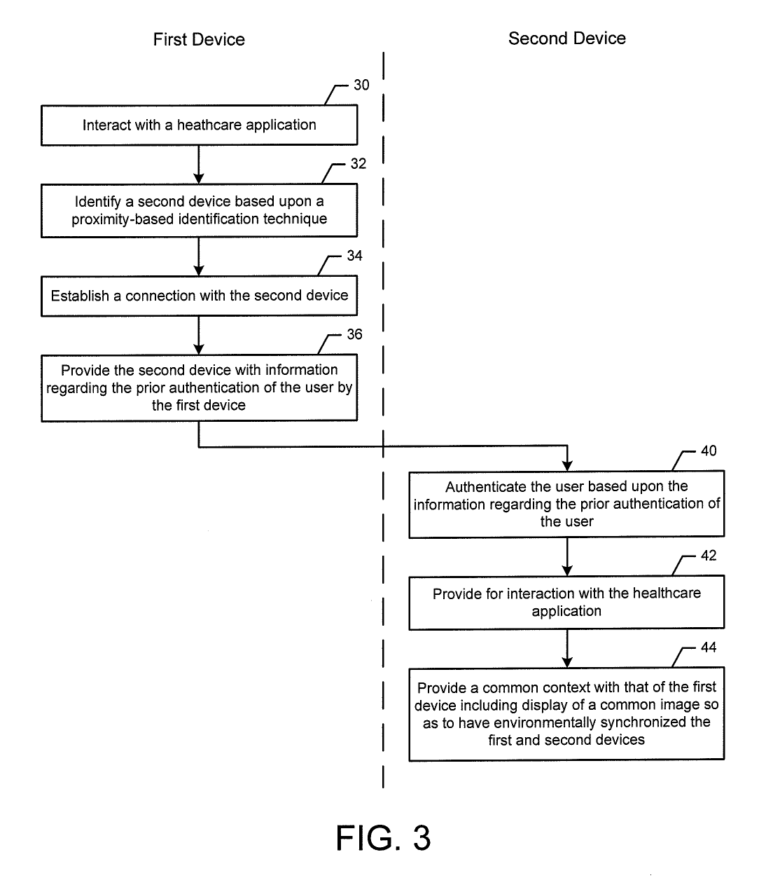

As shown in operation 30 of FIG. 3, a user may be initially interacting with a healthcare application via a first device, such as either the mobile terminal 12 or a workstation 10. In regards to the user's interaction with the healthcare application, the user may have launched the healthcare application utilizing the first device and may have navigated to a particular patient or study so as to review the images associated with the patient study as well as other related information. In order to have navigated to one or more particular images of a PACS patient study, a user may have had to make a number of selections in a sequential fashion.

While interacting with the healthcare application, such as while viewing an image presented by the first device, the user may determine that it would be desirable to migrate to another device, namely, a different type of device with a different degree of mobility, while continuing to interact with the healthcare application. In other words, a user who is interacting with a healthcare application upon a first device may desire to migrate to a second device, having either more or less mobility than the first device, while continuing to interact with the healthcare application.

In order to migrate from a first device to a second device, the method of one embodiment may identify the second device based upon a proximity-based identification technique. See operation 32 of FIG. 3. The method of example embodiments may employ a variety of different proximity-based identification techniques. For example, the second device may include or otherwise be associated with an identifier that uniquely identifies the second device and that may be read by the first device in order to identify the second device. For example, the identifier may be a barcode, a quick response (QR) code, a data matrix or other machine-readable code that is affixed on or proximate to the second device. In this embodiment, the first device may include a reader configured to read the barcode or QR code and to provide information representative of the barcode or QR code to the processor 22. Alternatively, the second device may present an identifier, such as a barcode, a QR code, an alphanumeric string, or other machine-readable code upon the display of the second device or an auxiliary display associated with the second device, thereby permitting the identifier to be changed more frequently so as to further increase the security. In this embodiment, the first device may include a reader to capture the machine-readable code or alphanumeric string and may provide the machine-readable code or alphanumeric string to the processor for subsequent analysis and identification of the second device. As an alternative to a reader, the first device may include a camera or other image capture device for capturing an image of the identifier. In the foregoing embodiments, the processor may be configured to analyze the identifier associated with the second device and to uniquely identify the second device based thereupon, such as by reference to memory 24 which may store associations between various identifiers and respective second devices. For example, the processor may decode the identifier and then identify an address, such as an internet protocol (IP) address, of the second device. Alternatively, the method and apparatus 20 of one embodiment may provide for the first device, such as the communication interface 26 of the first device, to communicate the identifier or a representation of the identifier to the healthcare application host 14 or to another network entity for analysis and identification of the second device. As such, the first device of this embodiment may receive an identification to the second device, such as an IP address of the second device, from the network, such as from the healthcare application host based upon the identifier or a representation of the identifier provided by the first device.

The method and apparatus 20 of other embodiments may identify the second device based upon other proximity-based identification techniques. For example, the first and second devices may be configured to exchange identifiers, such as addresses, based upon near field communications (NFC). For example, a workstation 10 and mobile terminal 12 may include respective NFC readers for receiving an identifier, such as an address, of the other device. Based upon the identifier, the second device may be identified in the manner described above. Alternatively, the mobile terminals and the workstations may include respective accelerometers such that the mobile terminal may be bumped or otherwise brought into temporary physical contact with the workstation. By comparing the accelerometer data provided by the accelerometers of the mobile terminal and the workstation, the first and second devices may be identified and paired together. Still further, the workstations within a facility may be geo-tagged and a mobile terminal may be provided with a map of the locations of the workstations so as to allow the user of a mobile terminal to locate an appropriate workstation. Once the mobile terminal of this embodiment is brought within a predefined proximity of a geo-tagged workstation, the mobile terminal may be caused to issue an alert and the user may be provided with an option to connect to the workstation. Regardless of the proximity-based identification technique that is utilized in order to identify the second device to which the user desires to migrate, the identification of the second device is facilitated by the method and apparatus embodiments of the present invention by eliminating requirements for the user to type or otherwise enter the address of the second device or to select the second device from a menu or other listing of candidate devices.

Once the second device has been identified, a connection may be established between the first and second devices, as shown in operation 34 of FIG. 3. In this regard, an apparatus 20 embodied by the first device, such as the processor 22, the communication interface 26 or the like, may establish a connection with the second device. As shown in FIG. 1, this connection may be a wireless connection, such as via a WLAN using Wi-Fi or the like. However, other types of connections between the first and second devices may be utilized in other embodiments, if so desired. In one embodiment the connection established with the second device is a secure connection, such as a hypertext transfer protocol secure (HTTPS) connection running over TCP/IP (transmission control protocol/internet protocol).

Once a connection has been established between the first and second devices, an apparatus 20 embodied by the first device, such as the processor 22, the communication interface 26 or the like, may provide the second device with information regarding the prior authentication of the user by the first device. See operation 36 of FIG. 3. In this regard, the apparatus embodied by the first device, such as the processor, may be configured to capture the authentication credentials and other login information of the user that was entered by the user, such as via the user interface 28 of the first device, in order to access the healthcare application via the first device. This information, such as the authentication credentials and other login information, may be stored in the memory 24 of the first device. Once a connection has been established with the second device, however, the information regarding the prior authentication, such as the authentication credentials and the other login information that was previously provided by the user in order to access the healthcare application, may be provided to the second device.

Once a connection has been established between the first and second devices and the second device has been provided with information regarding the prior authentication of the user by the first device, such as the authentication credentials and/or any other login information for the respective healthcare application, an apparatus 20 embodied by the second device, such as the processor 22 or the like, may authenticate the user based upon the information regarding the prior authentication of the user. See operation 40 of the FIG. 3. In this regard, the second device may communicate with the healthcare application host 14 and may provide the login information and authentication credentials previously utilized by the user when accessing the healthcare application via the first device so as to again authenticate the user, albeit in this instance via the second device. As such, the user may again be authenticated without having to enter, or actually re-enter, authentication information, such as authentication credentials and login information, since the authentication information that was previously utilized in order to access the healthcare application via the first device is reused in order to again access the healthcare application via the second device.

Once the user is authenticated, the apparatus 20 embodied by the second device, such as the processor 22 or the like, may provide for interaction with the healthcare application supported by the healthcare application host 14. See operation 42 of FIG. 3. In this regard, the apparatus embodied by the second device, such as a processor or the like, may cause the healthcare application to be launched or executed and output of the healthcare application may be provided via the user interface 28 of the second device. The second device, such as the processor, is also configured to environmentally synchronize with the first device. In order to environmentally synchronize the first and second devices, the apparatus embodied by the second device, such as the processor or the like, may be configured to provide a common context within the healthcare application with that of the first device at the time of the migration from the first device to the second device. See operation 44 of FIG. 3. By way of example, the context may include the identification of the same patient or study that was active and being reviewed at the time of the migration from the first device to the second device and the display of the same image relating to the patient or study that was being displayed by the first device at the time of the migration from the first device to the second device. The environmental synchronization of the first and second devices may be performed in an automated manner. In one embodiment, the healthcare application host 14 may maintain a record of the context of the first device and may recognize an instance in which the user migrates from the first device to the second device, such as a result of the authentication of the user by the second device with the authentication information previously utilized to authenticate the same user via the first device, and may then provide the second device with context of the first device at the time of the migration, such as by providing the second device with the same data from the patient or study including the same image that was provided to the first device and was being reviewed by the user at the time of the migration. Alternatively, the first device may provide the second device with information regarding the context of the healthcare application at the time of the migration, such as the patient and study context information. The second device of this embodiment may then provide the information identifying the context of the healthcare application to the healthcare application host such that the healthcare application host may, in turn, provide the corresponding information to the second device for display to the user.

By environmentally synchronizing the first and second devices, the user may migrate from the first device to the second device while continuing to view the same patient and/or study including, for example, the same image without having to repeat the navigation sequence through the healthcare application in order to recreate the environment or context at the time of the migration from the first device to the second device. Thus, the efficiency and ease with which a user may migrate from a first device to a second device is greatly improved as a result of the environmental synchronization therebetween. Although the resolution of the display of a mobile terminal 12 is generally sufficient to display PACS images in a suitable manner, in some instances in which the user migrates from a workstation 10 to a mobile terminal, the resolution of the display of the mobile terminal may be less than is desired to review a certain type of image, such as a mammography image. Thus, the apparatus 20 embodied by the mobile terminal may include means, such as the processor 22, user interface 28 or the like, for providing a disclaimer along with or otherwise in association with the images indicating that the resolution may not be sufficient for all diagnostic or other purposes.

As described above, FIG. 3 illustrates a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a workstation 10, a mobile terminal 12 or other computing device and executed by a processor (e.g., the processor 22) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowchart support combinations of means for performing the specified functions and combinations of steps for performing the specified functions. It will also be understood that one or more blocks of the flowchart, and combinations of blocks in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor 22 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method of migrating from a first device to a second device while interacting with a healthcare application, the method comprising:
cooperating with the first device to establish a connection therewith based upon a proximity-based identification technique, wherein a user is interacting with the healthcare application on the first device;
authenticating the user of the first device based upon information provided by the first device regarding prior authentication of the user by the first device; and
environmentally synchronizing with the first device including providing for interaction with the healthcare application via a processor and providing a common context with that of the first device including display of a common image.

2. A method according to claim 1 wherein environmentally synchronizing comprises providing data regarding a patient or a study being presented by the first device upon migration therefrom.

3. A method according to claim 1 wherein environmentally synchronizing comprises launching the healthcare application.

4. A method according to claim 1 further comprising providing an identifier for recognition by the proximity-based identification technique.

5. A method according to claim 1 wherein authenticating the user of the first device comprises receiving authentication credentials of the user of the first device.

6. An apparatus for migrating from a first device to a second device while interacting with a healthcare application, the apparatus comprising a processor configured to cause the apparatus to:
cooperate with the first device to establish a connection therewith based upon a proximity-based identification technique, wherein a user is interacting with the healthcare application on the first device;
authenticate the user of the first device based upon information provided by the first device regarding prior authentication of the user by the first device; and
environmentally synchronize with the first device including interaction with the healthcare application and provision of a common context with that of the first device including display of a common image.

7. An apparatus according to claim 6 wherein the processor is configured to cause the apparatus to environmentally synchronize with the first device by providing data regarding a patient or a study being presented by the first device upon migration therefrom.

8. An apparatus according to claim 6 wherein the processor is configured to cause the apparatus to environmentally synchronize with the first device by launching the healthcare application.

9. An apparatus according to claim 6 wherein the processor is further configured to cause the apparatus to provide an identifier for recognition by the proximity-based identification technique.

10. An apparatus according to claim 6 wherein the processor is configured to cause the apparatus to authenticate the user of the first device by receiving authentication credentials of the user of the first device.

11. A method of migrating from a first device to a second device while interacting with a healthcare application, the method comprising:
interacting with the healthcare application via a processor including display of an image;
establishing a connection with the second device based upon a proximity-based identification technique; and
providing information to the second device regarding prior authentication of the user by the first device to permit authentication of the user of the first device by the second device and to permit the second device to be environmentally synchronized with the first device including interaction with the healthcare application and provision of a common context with that of the first device including display of the image.

12. A method according to claim 11 wherein establishing the connection with the second device comprises reading an identifier of the second device and identifying the second device based upon the identifier.

13. A method according to claim 11 further comprising providing information regarding the context of the first device.

14. A method according to claim 11 wherein interacting with the healthcare application comprises providing data regarding a patient or a study via the display of the image.

15. A method according to claim 11 wherein providing information comprises providing authentication credentials of the user of the first device to the second device.

16. An apparatus of migrating from a first device to a second device while interacting with a healthcare application, the apparatus comprising a processor configured to cause the apparatus to:
interact with the healthcare application including display of an image;
establish a connection with the second device based upon a proximity-based identification technique; and
provide information to the second device regarding prior authentication of the user by the first device to permit authentication of the user of the first device by the second device and to permit the second device to be environmentally synchronized with the first device including interaction with the healthcare application and provision of a common context with that of the first device including display of the image.

17. An apparatus according to claim 16 wherein the processor is configured to cause the apparatus to establish the connection with the second device by reading an identifier of the second device and identifying the second device based upon the identifier.

18. An apparatus according to claim 16 wherein the processor is further configured to cause the apparatus to provide information regarding the context of the first device.

19. An apparatus according to claim 16 wherein the processor is configured to cause the apparatus to interact with the healthcare application by providing data regarding a patient or a study via the display of the image.

20. An apparatus according to claim 16 wherein the processor is configured to cause the apparatus to provide information by providing authentication credentials of the user of the first device to the second device.
